(19) United States
(12) Patent Application Publication
(10) Pub. No.: US 2009/0195657 A1
(43) Pub. Date: Aug. 6, 2009

(54) OSD system and method for controlling the same

(75) Inventors: Huan-Xi Peng, Shenzhen (CN); Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/322,494

(22) Filed: Feb. 2, 2009

(30) Foreign Application Priority Data
Feb. 1, 2008 (CN) 200810066036.4

(51) Int. Cl. H04N 17/04

(52) U.S. Cl. 348/177; 348/E17.006

(57) ABSTRACT

An onscreen display (OSD) system for a display device includes an OSD module including a microprocessor and a memory. The memory stores instructions about adjustment of a display characteristic and the microprocessor reads the instructions and generates an OSD menu including the instructions. An operation method for the system is also provided.

The present disclosure relates to an onscreen display (OSD) system and an operation method thereof.

### GENERAL BACKGROUND

In general, most computer monitors provide an OSD displaying information relating to adjustment of display characteristics and information about the monitor itself. The OSD activated on the screen of the monitor generally includes a plurality of menus for altering aspects such as shape, color, and other characteristics of the display, providing a preferred display mode.

To adjust the display, some of the characteristics of the display as mentioned above should be adjusted under some special conditions, some of which require display of special images. If users adjust these characteristics during display of common images, adjustment of the characteristics is not easy, and much more time consuming. For instance, if H/V Position is to be adjusted while a full-screen image is displayed, it is preferable when the Phase is adjusted that the image displayed show 256 equally sized listings, each with larruping brightness.

It should be understood that most users will lack the technical expertise to utilize the requisite images corresponding to these characteristics during adjustment, making it difficult for the display to be corrected.

Therefore, an OSD system and an operation method thereof that can overcome the described problems are desired.

### BRIEF DESCRIPTION OF THE DRAWINGS

FIG. 1 is a block diagram of an OSD system of a display device according to a first embodiment of the present disclosure.

FIG. 2 is a block diagram of an OSD menu generated by the OSD system of FIG. 1.

FIG. 3 is a flowchart of an operation method the OSD system of FIG. 1.

FIG. 4 is a block diagram of an OSD menu generated by an OSD system according to a second embodiment of the present disclosure.

### DETAILED DESCRIPTION OF EMBODIMENTS

Reference will now be made to the drawings to describe the present disclosure in detail.

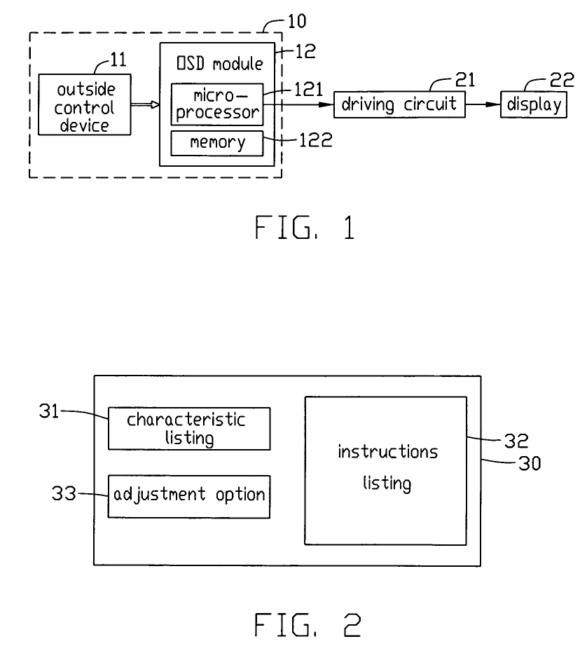

FIG. 1 is a block diagram of an OSD system of a display device according to a first embodiment of the present disclosure. The OSD system 10 includes an outside control device 11 and an OSD module 12. The OSD system 10 controls display parameters of a display 22 via a driving circuit 21.

The outside control device 11 adjusts the OSD module 12, and can be a keyboard, a mouse, or a series of controls on the exterior of the display 22.

The OSD module 12 includes a microprocessor 121 and a memory 122 connected thereto. The microprocessor 121 executes instructions and identifies operation information transferred from the outside control device 11 to the OSD module 12. The microprocessor 121 also performs actions based on the program group recorded at the beginning. The memory 122 is a Non-volatile Random Access Memory (NVRAM), and stores the instructions required to adjust a characteristic of the display 22. The instructions include a plurality of groups of image and text messages. Each group of image and text messages corresponds to one of the characteristics of the display 22.

The OSD module 12 generates and shows the OSD menu on the display 22. Referring to FIG. 2, a block diagram of an OSD menu generated by the OSD system 10 is shown. The OSD menu 30 includes a characteristic listing 31, an instruction listing 32, and an adjustment option 33. The characteristic listing 31 displays the characteristic to be adjusted. The instruction listing 32 displays a group of image and text messages corresponding to the characteristic to be adjusted.

In operation, for example, a first control signal is input to the microprocessor 121, here, to adjust contrast ratio of the display 22. The characteristic listing 31 shows the information “contrast ratio”. The microprocessor 121 identifies the first control signal, reads a corresponding program group, and executes the program group and generates the OSD menu 30 on the display 22. At the same time, the microprocessor 121 retrieves a group of image and text messages corresponding to contrast ratio adjustment from the memory 121 and displays the group via the instruction listing 32.

The instructions as displayed describe how to adjust the contrast ratio for better performance. At this time, the outside control device 11 can be used to select the adjustment option 33, thereby inputting a second control signal to the microprocessor 121. The microprocessor 121 reads and executes the corresponding program group, and displays the image shown on the instructions listing 32.

In the present disclosure, the OSD module 12 of the OSD system 10 includes the memory 122 storing the instructions and generating the OSD menu 30 including the instructions. Thus, adjustment of the characteristics of the display 22 is enabled by requisite information, improving the adjustment performance. As well, images optimal for making the adjustment are provided, making the adjustment more convenient.

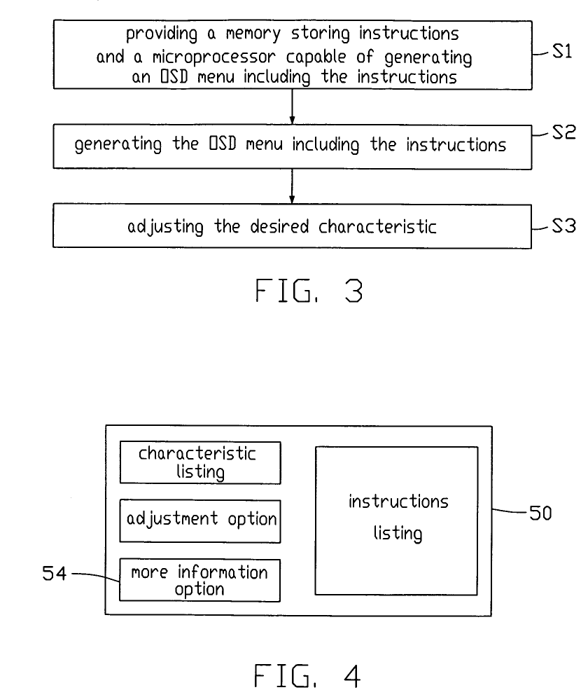

Referring to FIG. 3, a flowchart of an operation method of an OSD system 10 is shown. In Step S1, a memory storing instructions and a microprocessor generating an OSD menu including the instructions are provided. In Step S2, the OSD menu including the instructions is generated. In Step S3, the value of the desired characteristic is adjusted. The steps are described in detail as follows.

In Step S1, memory 122 storing instructions and microprocessor 121, capable of reading the instructions and generating an OSD menu 30 including the instructions are provided.

In Step S2, the outside device 11 directs microprocessor 121 to read a corresponding program group stored therein. Microprocessor 121 executes the program group and generates OSD menu 30. Microprocessor 121 also reads the instructions and displays the instructions on the OSD menu 30.

In Step S3, based on the instructions shown on the OSD menu 30, the outside device 11 is used to select the adjustment option 33, directing the image corresponding to the desired characteristic to be shown on display 22. The value of the characteristic is then adjusted.

FIG. 4 is a block diagram of an OSD menu generated by an OSD system according to a second embodiment of the present disclosure, differing from the previous embodiment only in that the OSD menu 50 further includes a “more information” option 54. When the more information option 54 is selected, an OSD module generates an additional window displaying helpful information to learn more about the characteristic presently shown.

Alternative embodiments may further include the OSD menu 30 including a “next image” option, whereby the image shown at the instructions listing 32 is changed.

While the disclosure has been described by way of example and in terms of preferred embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An onscreen display (OSD) system for a display device, comprising an OSD module, the OSD module comprising:
a memory storing instructions; and
a microprocessor capable of reading the instructions from the memory and generating an OSD menu comprising the instructions.

2. The OSD system of claim 1, wherein the OSD menu comprises an instruction listing.

3. The OSD system of claim 2, wherein the instructions comprise a plurality of image groups, each image group corresponding to at least one characteristic of the display device.

4. The OSD system of claim 3, wherein the OSD menu further comprises an adjustment option, which, when selected, causes the display device to load an image from the image group.

5. The OSD system of claim 4, wherein the OSD menu further comprises a more information listing, and is capable of generating a “more information” window showing more information regarding the currently adjusted characteristic, the additional information stored in the memory.

6. The OSD system of claim 4, wherein the OSD menu further comprises a “next image” option, which, when selected, causes the OSD module to change the image shown at the instruction listing.

7. The OSD system of claim 1, further comprising an outside control device electronically connected to the OSD module.

8. The OSD system of claim 7, wherein the outside control device is one or more of a keyboard, mouse, or control.

9. An onscreen display (OSD) operation method, comprising:
providing a memory, storing instructions, and a microprocessor capable of generating an OSD menu comprising the instructions;
generating the OSD menu comprising the instructions; and
adjusting the value of the waiting-adjusted characteristic.

10. The OSD operation method of claim 9, wherein the instructions comprise image groups, each image group corresponding to at least one display characteristic.

11. The OSD operation method of claim 10, wherein the OSD menu comprises instruction listings configured for displaying at least one image of the image group corresponding to the display characteristic to be adjusted.

12. The OSD operation method claimed as claim 11, further comprising loading one image of the image group corresponding to the display characteristic to be adjusted.

13. The OSD operation method claimed as claim 9, further comprising providing an outside device configured for inputting operating commands to the microprocessor.

14. The OSD operation method claimed as claim 10, further comprising selecting the image shown at the instructions listing.
